(19) United States
(12) Patent Application Publication
(10) Pub. No.: US 2016/0239363 A1
(43) Pub. Date: Aug. 18, 2016

(54) ANALYSIS DEVICE AND INFORMATION PROCESSING SYSTEM

(71) Applicant: FUJITSU LIMITED, Kawasaki-shi (JP)

(72) Inventor: TATSUMA MATSUKI, Kawasaki (JP)

(21) Appl. No.: 14/993,317

(22) Filed: Jan. 12, 2016

(30) Foreign Application Priority Data
Feb. 13, 2015 (JP) 2015-026592

(51) Int. Cl. G06F 11/07

(52) U.S. Cl. CPC G06F 11/079; G06F 11/0709; G06F 11/0751; G06F 11/0787

(57) ABSTRACT

An analysis device includes a storage device and a processor. The storage device is configured to store therein performance information of each subject which is any type of performance of any device or any process in an information processing device. The processor is configured to acquire first performance information of a first subject from the information processing device and compare the first performance information with performance information of the first subject previously stored in the storage device to calculate a variation rate. The processor is configured to store the first performance information in the storage device when the variation rate exceeds a predetermined variation rate. The processor is configured to calculate a sampling rate for each subject and determine analysis candidate subjects which have a sampling rate higher than a predetermined sampling rate. The processor is configured to analyze a relationship between performance information of the analysis candidate subjects.

### CROSS-REFERENCE TO RELATED APPLICATION

This application is based upon and claims the benefit of priority from the prior Japanese Patent Application No. 2015-026592, filed on Feb. 13, 2015, the entire contents of which are incorporated herein by reference.

### FIELD

The embodiment discussed herein is related to an analysis device and an information processing system.

### BACKGROUND

An enormous amount and types of time-series data, which change every moment of every day, are produced from information processing systems. The time-series data is stored information in which performance information, which indicates operation status of various devices such as servers or switches included in the information processing system or various processes executed in the information processing system, is associated with measurement time of the performance information. Based on the performance information, a system administrator determines the state of the overall system and conducts an analysis regarding, for example, a cause or symptom of an error.

For example, upon occurrence of an error, a system administrator finds out an abnormality in a usage rate of a central processing unit (CPU) of a server. In this case, if a relationship is discovered between the CPU usage rate of the server and a CPU usage rate of a virtual machine operating in the server, it is possible to estimate that the error is attributed to the virtual machine. As described above, if a system administrator recognizes a pair (a CPU usage rate of a server and a CPU usage rate of a virtual machine operating in the server) of time-series data having a relationship, it would be useful for a case of, for example, identifying a cause of an error or detecting a symptom of an error.

There has been known a maintenance information management system, which provides a system administrator with maintenance information handling an error occurring during the operation of a device. This maintenance information management system provides a system administrator with operation information having high consistency with past operation information, as the maintenance information.

There has been known a technology, which changes an interval of saving data depending on a variation amount of time-series data.

Related techniques are disclosed in, for example, Japanese Laid-Open Patent Publication No. 2005-275713 and Japanese Laid-Open Patent Publication No. 10-143543.

As the number of information processing devices increases within an information processing system, a data amount of performance information becomes bulky. Further, since a pair of time-series data having a relationship also includes a relationship of different types of time-series data between information processing devices, the number of combinations of time-series data is enormous. As a result, as an information processing system becomes larger in a scale, it would be difficult for a system administrator to understand a relationship of various types of time-series data.

### SUMMARY

According to an aspect of the present invention, provided is an analysis device including a storage device and a processor. The storage device is configured to store therein performance information of each of plural subjects. Each of the plural subjects is any type of performance of any device or any process in an information processing device. The processor is configured to acquire first performance information of a first subject of the plural subjects from the information processing device. The processor is configured to compare the first performance information and a reference value with each other to calculate a variation rate. The reference value indicates performance information of the first subject previously stored in the storage device. The processor is configured to store the first performance information in the storage device when the variation rate exceeds a predetermined variation rate. The processor is configured to calculate a sampling rate for each of the plural subjects. The sampling rate indicates a ratio of a number of performance information stored in the storage device to a number of performance information acquired from the information processing device within a predetermined time period. The processor is configured to determine analysis candidate subjects which have a sampling rate higher than a predetermined sampling rate. The processor is configured to analyze a relationship between performance information of the analysis candidate subjects on basis of the performance information stored in the storage device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of an information processing system according to an embodiment;

FIG. 2 is a diagram illustrating an exemplary hardware configuration of an analysis device;

FIG. 3A is a diagram illustrating an example of sampling processing;

FIG. 3B is a diagram illustrating an example of sampling processing;

FIG. 4 is a diagram illustrating an exemplary method for calculating a sampling rate;

FIG. 5 is a diagram illustrating an example of analysis candidate information indicating a sampling rate of performance information;

FIG. 6 is a diagram illustrating an example of visualized performance information;

FIG. 7 is a diagram illustrating an example of a correlation coefficient for a pair of analysis-candidate performance information;

FIG. 8 is a flowchart illustrating an example of sampling processing;

FIG. 9 is a flowchart illustrating an example of visualization analysis; and

FIG. 10 is a flowchart illustrating an example of relationship analysis using a correlation coefficient.

### DESCRIPTION OF EMBODIMENT

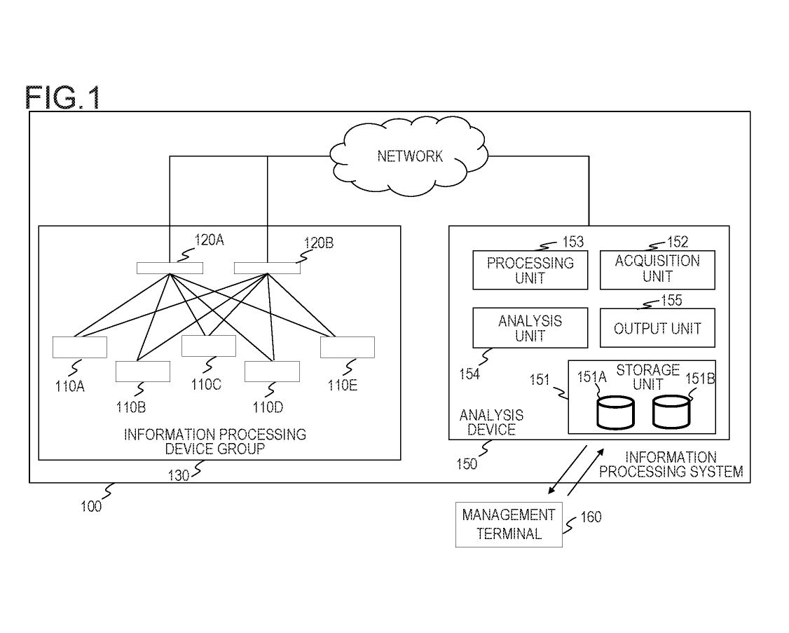

Hereinafter, an embodiment is described in detail with reference to the accompanying drawings. FIG. 1 illustrates an exemplary configuration of an information processing system according to the embodiment. An information processing system 100 includes an information processing device group 130 and an analysis device 150. The information processing device group 130 includes, for example, servers 110A to 110E and switches 120A and 120B. Hereinafter, each of the servers 110A to 110E and the switches 120A and 120B may be referred to as an information processing device. The terms “servers 110A to 110E” and “switches 120A and 120B” do not necessarily limit the number of the servers and the switches.

The information processing device measures, at constant time intervals, performance information of various types of devices and processes such as a CPU, a disk, and a memory mounted therein, a network connected thereto, and processes running thereon. The information processing device stores the performance information in association with measurement time at which the performance information is measured. Accordingly, the performance information stored in the information processing device is time-series data. Hereinafter, performance information of various types of devices or processes is collectively referred to as “performance information of various subjects”. In addition, performance information of an individual device or process may be referred to as “performance information of each subject”. Hereinafter, the time-series data may be referred to as “performance information”.

The analysis device 150 includes a storage unit 151, an acquisition unit 152, a processing unit 153, an analysis unit 154, and an output unit 155. The storage unit 151 includes two (2) memory areas, that is, storage areas 151A and 151B. The analysis device 150 is connected to a management terminal 160 which is operated by a system administrator when using the analysis device 150. Hereinafter, analysis processing performed by the analysis device 150 will be described.

Here, it is assumed that there is performance information D0, D1, D2, and D3 in an information processing device. The performance information D3 is the latest performance information. The performance information D0 to D3 is acquired within the information processing device at different timings. It is also assumed that an analysis of performance information D0 to D2 has been completed by the analysis device 150 and the performance information D0 to D2 is stored in the storage areas 151A and 151B. For example, D0 includes performance information of plural subjects, which is measured at an identical timing.

The information processing device transmits the latest performance information D3, which has been newly measured, to the analysis device 150. The acquisition unit 152 acquires the performance information D3 including performance information of plural subjects. Upon acquiring the latest performance information D3 including performance information of each subject, the acquisition unit 152 performs sampling processing in order to reduce a data amount of the performance information. The sampling processing is processing for extracting data. When performing the sampling processing, the acquisition unit 152 stores the latest performance information D3 of each subject in the storage area 151B of the storage unit 151. As a result, the storage area 151B stores the performance information D0 to D3. The acquisition unit 152 stores, for example, the performance information of each subject, which have been acquired for the latest three (3) times (D1 to D3), in the storage area 151B, and deletes the performance information D0 acquired before that from the storage area 151B. The storage area 151B may temporarily store the recently acquired information. The storage area 151B stores the performance information of each subject for three (3) times in the embodiment, however, the number of times is not limited to three (3).

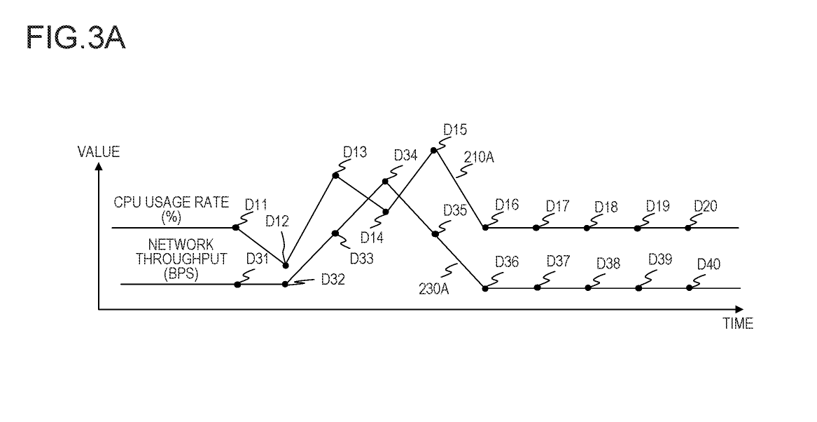

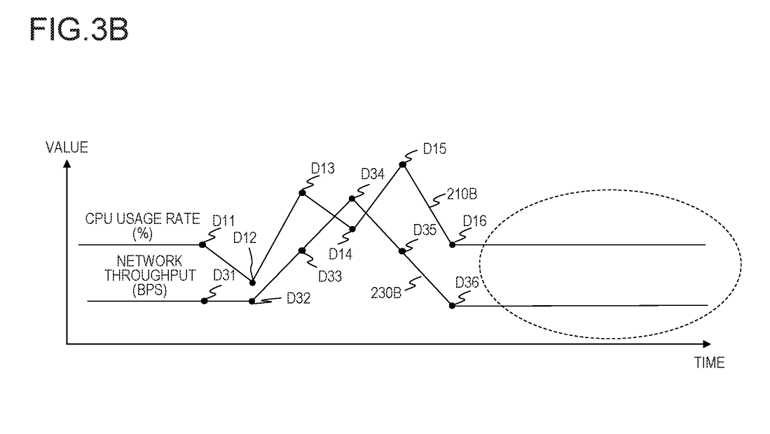

The acquisition unit 152 reads, from the storage area 151A, a reference value RV (which will be described in detail later with reference to FIGS. 3A and 3B), which is performance information of each subject lastly stored in the storage area 151A. Here, performance information D0 to D2 is stored in the storage area 151A, and the performance information lastly stored in the storage area 151A is the performance information D2. Accordingly, the reference value RV is updated to D2.

The acquisition unit 152 compares the reference value RV and the latest performance information D3 of the same type as the reference value RV with each other, in order to determine whether a variation rate from the reference value exceeds a predetermined threshold value. The processing for comparing the reference value RV and the latest performance information D3 with each other is performed for every subject. When it is determined that the variation rate does not exceeds the predetermined threshold value, the acquisition unit 152 discards the latest performance information D3 without storing the latest performance information D3 in the storage area 151A. When it is determined that the variation rate exceeds the predetermined threshold value, the acquisition unit 152 stores the latest performance information D3 in the storage area 151A. In addition, the acquisition unit 152 reads, from the storage area 151B, the performance information D2 acquired immediately before the latest performance information D3 and stores the performance information D2 in the storage area 151A. In this example, since the performance information D2 has been already stored in the storage area 151A, the performance information D2 is not stored again in the storage area 151A.

Next, the reference value RV is updated to the latest performance information D3 newly stored in the storage area 151A. This sampling processing is performed for the latest performance information of every subject acquired by the acquisition unit 152. The sampling processing is performed every time the performance information is acquired from the information processing device, and the reference value RV is different for performance information type of each subject.

As described above, the acquisition unit 152 performs the sampling processing such that a data amount of performance information to be stored in the analysis device 150 may be reduced.

The information processing system 100 according to the embodiment analyzes the relationship of the performance information between the respective types and between the respective information processing devices, on the basis of the performance information of which a data amount has been reduced by the sampling processing. Hereinafter, the performance information D0 to D3 stored in the storage area 151A after the sampling processing is referred to as “acquired performance information”. The analysis of a relationship of performance information is performed when a system administrator specifies and inputs a time period to be analyzed into the analysis device 150. The system administrator inputs a time period to be analyzed through, for example, the management terminal 160 of the analysis device 150. The processing unit 153 acquires values indicating the time period to be analyzed that have been input by the system administrator. The processing unit 153 calculates, for each subject in the entire information processing device, a sampling rate indicating a rate of sampling of the performance information stored in the storage area 151A, within the specified time period. The processing unit 153 extracts, as “analysis-candidate performance information”, performance information having a larger sampling rate than a predetermined threshold value.

The analysis unit 154 calculates a correlation coefficient for a pair of the extracted analysis-candidate performance information in all combinations. The correlation coefficient is a value indicating a similarity of the performance information. A correlation coefficient is an example of a relationship. By identifying a pair of analysis-candidate performance information having a correlation coefficient close to 1, it is possible to identify a pair of performance information of subjects having a relationship.

It is highly likely that there is no correlation in performance information having significantly different sampling rates. Thus, in calculating a correlation coefficient, a correlation coefficient for a pair of performance information having close sampling rates may be preferentially calculated, and when a predetermined number of calculation results are obtained, the analysis unit 154 may finish the analysis processing. As a result, a time required for an analysis may be reduced, compared to calculating a correlation coefficient of a pair of analysis-candidate performance information in all combinations. The output unit 155 may visualize information indicating a pair of performance information having a correlation coefficient larger than the predetermined threshold value in a form of, for example, a graph or a table, or the like, and display the information on a monitor of the management terminal 160 or the like. As a result, the system administrator may easily identify a pair of performance information having a relationship.

The output unit 155 may visualize the analysis-candidate performance information in a form of, for example, a graph, a table, or the like, and display the performance information on a monitor of the management terminal 160 or the like. The analysis-candidate performance information is performance information having a high sampling rate and variation rate in a time period specified by the system administrator. The performance information having a high sampling rate in a time period where a system error is occurring is highly likely to be related to the system error. Accordingly, by notifying the system administrator of performance information having a high variation rate in a time period specified by the system administrator, the subjects to be used in the analysis of performance information, such as analysis of a cause of a system error or detection of a symptom thereof, are decreased so that the analysis of performance information may be performed at a high speed.

As described above, the acquisition unit 152 performs the sampling processing so that a data amount of performance information to be stored in the analysis device 150 may be reduced. As the processing unit 153 extracts performance information having a higher sampling rate than a predetermined threshold value as analysis-candidate performance information, the time required for the analysis may be reduced. The analysis unit 154 determines a pair of performance information having close sampling rates among the extracted analysis-candidate performance information to be preferentially subjected to the calculation of a correlation coefficient, and calculates the correlation coefficient until a predetermined number of results are obtained. As a result, the time required for the processing of calculating a correlation coefficient may be reduced.

The system administrator may specify a time period where no error has occurred in the information processing system 100, and acquire a pair of performance information of each subject, which has a high correlation coefficient, in the entire information processing device, in order to detect the subject for which performance information is to be analyzed. Also, the system administrator may specify a time period where a system error has occurred and acquire a pair of performance information of each subject, which has a high correlation coefficient, in the entire information processing device, in order to determine a subject having performance information affected by the error. As a result of the decrease of subjects to be used in the analysis of performance information, such as analysis of a cause of a system error or detection of a symptom thereof, the system administrator may perform the analysis of performance information at a high speed.

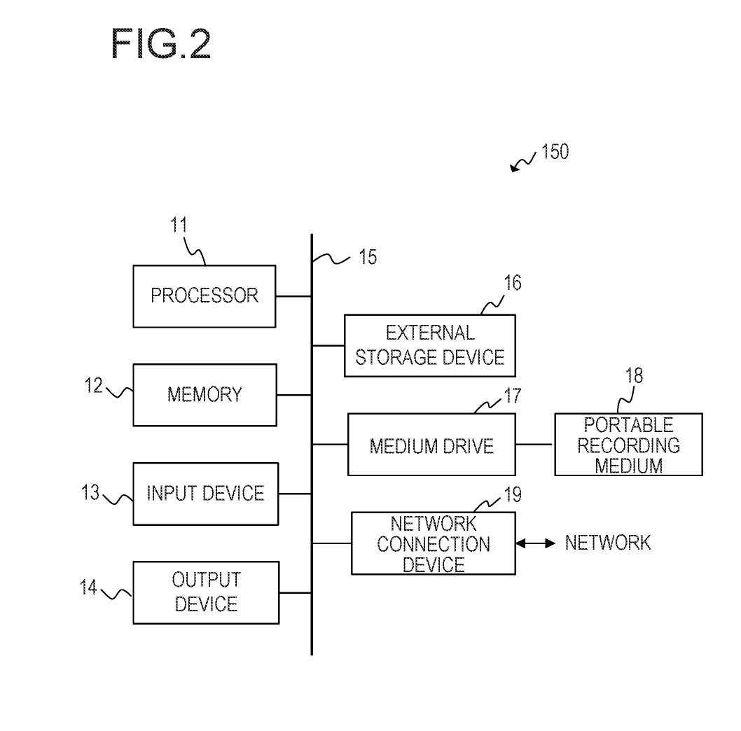

FIG. 2 illustrates an exemplary hardware configuration of the analysis device. The analysis device 150 includes a processor 11, a memory 12, a bus 15, an external storage device 16, and a network connection device 19. The analysis device 150 may include an input device 13, an output device 14, and a medium drive 17. The analysis device 150 may be implemented by, for example, a computer.

The processor 11 may be an arbitrary processing circuit including a CPU. In the analysis device 150, the processor 11 operates as the acquisition unit 152, the processing unit 153, and the analysis unit 154. The processor 11 may execute a program stored in, for example, the external storage device 16. The memory 12 operates as the storage unit 151 and holds the performance information. The memory 12 also stores data obtained by the operation of the processor 11 and data used for processing by the processor 11. The network connection device 19 is an interface used for communication with other devices.

The input device 13 may be, for example, a button, a keyboard, a mouse, or the like. The output device 14 may be a display or the like. The bus 15 connects the processor 11, the memory 12, the input device 13, the output device 14, the external storage device 16, the medium drive 17, and the network connection device 19 to enable a mutual data transfer with each other. The external storage device 16 stores programs, data, or the like. The external storage device 16 may be, for example, a hard disk drive (HDD) or a solid state drive (SSD). The information stored in the external storage device 16 is provided to the processor 11 or the like. The medium drive 17 may output data stored in the memory 12 or the external storage device 16 to a portable recording medium 18. Also, the medium drive 17 may read programs, data, or the like from the portable recording medium 18. The portable recording medium 18 may be any recording medium, which may be carried, such as a flexible disk, a magneto-optical (MO) disk, a compact disc recordable (CD-R) or a digital versatile disc recordable (DVD-R). The portable recording medium 18 may be a semiconductor memory card such as a flash memory, and the medium drive 17 may be a reader/writer for a memory card. Each of the memory 12, the external storage device 16, and the portable recording medium 18 is an example of a tangible storage medium.

FIGS. 3A and 3B illustrate an example of sampling processing. FIG. 3A is an example of performance information before the sampling processing. FIG. 3B is an example of performance information after the sampling processing of the performance information of FIG. 3A.

In the example of FIG. 3A, the acquisition unit 152 acquires performance information indicating a CPU usage rate for ten (10) times. The ten (10) performance information acquired by the acquisition unit 152 is D11 to D20. Performance information 210A is represented as a line connecting the performance information D11 to D20 indicating the CPU usage rates. In the performance information 210A, the vertical axis of FIG. 3A refers to the percentage (%) indicating a CPU usage rate, and the horizontal axis thereof refers to the time when a CPU usage rate is measured. The performance information 210A indicates that the CPU usage rate in the information processing device fluctuates during the time indicated by the performance information D11 to D16. In contrary, the performance information 210A indicates that the CPU usage rate in the information processing device is stable during the time indicated by the performance information D16 to D20.

The acquisition unit 152 acquires performance information of a network throughput from the same information processing device, in addition to the performance information of the CPU usage rate. In the example of FIG. 3A, the acquisition unit 152 acquires performance information indicating a network throughput for ten (10) times. The ten (10) performance information acquired by the acquisition unit 152 is D31 to D40. Performance information 230A is represented as a line connecting the performance information D31 to D40 indicating the network throughputs. In the performance information 230A, the vertical axis of FIG. 3A refers to a bit per second (bps), which indicates a processing speed of a network throughput, and the horizontal axis thereof refers to the time when a network throughput is measured. The performance information 230A indicates that the network throughput in the information processing device fluctuates during the time indicated by the performance information D31 to D36. In contrary, the performance information 230A indicates that the network throughput in the information processing device is stable during the time indicated by the performance information D36 to D40. Here, for example, the performance information D11 and D31 are acquired by the acquisition unit 152 from the information processing device at the same timing.

Performance information 210B of FIG. 3B corresponds to an example of performance information after the sampling processing of the performance information 210A of FIG. 3A. Performance information 230B of FIG. 3B corresponds to an example of performance information after the sampling processing of the performance information 230A of FIG. 3A.

In the sampling processing according to the embodiment, a reference value RV and the latest acquired performance information are compared with each other, and when it is determined that a variation rate from the reference value does not exceeds a predetermined threshold value, an index value of the latest acquired performance information is discarded. Hereinafter, an example of the sampling processing by the acquisition unit 152 for the performance information 230A will be described.

(A1) The acquisition unit 152 acquires the performance information D31. At this time, it is assumed that the storage area 151A does not hold any performance information. Thus, there is no value set for a reference value RV.

(A2) The acquisition unit 152 stores the performance information D31 in the storage area 151B (1^{st} generation).

(A3) Since there is no reference value RV to be compared with the performance information D31, the acquisition unit 152 stores the performance information D31 in the storage area 151A. The acquisition unit 152 set the performance information D31 as a reference value RV.

(A4) The acquisition unit 152 acquires the performance information D32. (A5) The acquisition unit 152 stores the performance information D32 in the storage area 151B (2^{nd} generation).

(A6) The acquisition unit 152 performs sampling processing. The acquisition unit 152 compares the reference value RV (the performance information D31) and the latest performance information D32 with each other and determines that a variation rate does not exceed a predetermined threshold value. Thus, the acquisition unit 152 does not store the performance information D32 in the storage area 151A (discarding the performance information D32). Accordingly, the reference value RV is still the performance information D31.

(A7) The acquisition unit 152 acquires the performance information D33. (A8) The acquisition unit 152 stores the performance information D33 in the storage area 151B (3^{rd} generation).

(A9) The acquisition unit 152 performs the sampling processing. The acquisition unit 152 compares the reference value RV (the performance information D31) and the latest performance information D33 with each other, and determines that a variation rate exceeds the predetermined threshold value.

(A10) The acquisition unit 152 stores the performance information D33 in the storage area 151A. In addition, the acquisition unit 152 reads, from the storage area 151B, the performance information D32, which has been acquired immediately before the latest performance information D33, and stores the performance information D32 in the storage area 151A. The acquisition unit 152 updates the reference value RV to the latest performance information D33 within the storage area 151A.

(A11) The acquisition unit 152 acquires the performance information D34. (A12) The acquisition unit 152 stores the performance information D34 in the storage area 151B (4^{th} generation). The acquisition unit 152 deletes the old generation performance information D31 from the storage area 151B.

(A13) The acquisition unit 152 performs the sampling processing. The acquisition unit 152 compares the reference value RV (the performance information D33) and the latest performance information D34 with each other, and determines that a variation rate exceeds the predetermined threshold value.

(A14) The acquisition unit 152 stores the performance information D34 in the storage area 151A. In addition, the acquisition unit 152 attempts to store the performance information D33, which has been acquired immediately before the latest performance information D34, in the storage area 151A. Since the performance information D33 is already stored in the storage area 151A in the processing of (A10), the processing for storing the performance information D33 in the storage area 151A is not performed. The acquisition unit 152 sets the latest performance information D34 within the storage area 151A as a reference value RV.

(A15) The acquisition unit 152 acquires the performance information D35. (A16) The acquisition unit 152 stores the performance information D35 in the storage area 151B. The acquisition unit 152 deletes the old generation performance information D32 from the storage area 151B.

(A17) The acquisition unit 152 performs the sampling processing. The acquisition unit 152 compares the reference value RV (the performance information D34) and the latest performance information D35 with each other and determines that a variation rate exceeds the predetermined threshold value.

(A18) The acquisition unit 152 stores the performance information D35 in the storage area 151A. In addition, the acquisition unit 152 attempts to store the performance information D34, which has been acquired immediately before the latest performance information D35, in the storage area 151A. Since the performance information D34 is already stored in the storage area 151A in the processing of (A14), the processing for storing the performance information D34 in the storage area 151A is not performed. The acquisition unit 152 updates the reference value RV to the latest performance information D35 within the storage area 151A.

(A19) The acquisition unit 152 acquires the performance information D36. (A20) The acquisition unit 152 stores the performance information D36 in the storage area 151B. The acquisition unit 152 deletes the old generation performance information D33 from the storage area 151B.

(A21) The acquisition unit 152 performs the sampling processing. The acquisition unit 152 compares the reference value RV (the performance information D35) and the latest performance information D36 with each other and determines that a variation rate exceeds the predetermined threshold value.

(A22) The acquisition unit 152 stores the performance information D36 in the storage area 151A. In addition, the acquisition unit 152 attempts to store the performance information D35, which has been acquired immediately before the latest performance information D36, in the storage area 151A. Since the performance information D35 is already stored in the storage area 151A in the processing of (A18), the processing for storing the performance information D35 in the storage area 151A is not performed. The acquisition unit 152 updates the reference value RV to the latest performance information D36 within the storage area 151A.

(A23) The acquisition unit 152 acquires the performance information D37. (A24) The acquisition unit 152 stores the performance information D37 in the storage area 151B. The acquisition unit 152 deletes the old generation performance information D34 from the storage area 151B.

(A25) The acquisition unit 152 performs the sampling processing. The acquisition unit 152 compares the reference value RV (the performance information D36) and the latest performance information D37 with each other, and determines that a variation rate does not exceed the predetermined threshold value. Thus, the acquisition unit 152 does not store the performance information D37 in the storage area 151A (discarding). Accordingly, the reference value RV is still the performance information D36.

(A26) The acquisition unit 152 acquires the performance information D38. (A27) The acquisition unit 152 stores the performance information D38 in the storage area 151B. The acquisition unit 152 deletes the old generation performance information D35 from the storage area 151B.

(A28) The acquisition unit 152 performs the sampling processing. The acquisition unit 152 compares the reference value RV (the performance information D36) and the latest performance information D38 with each other, and determines that a variation rate does not exceed the predetermined threshold value. Thus, the acquisition unit 152 does not store the performance information D38 in the storage area 151A (discarding). Accordingly, the reference value RV is still the performance information D36.

(A29) The acquisition unit 152 acquires the performance information D39. (A30) The acquisition unit 152 stores the performance information D39 in the storage area 151B. The acquisition unit 152 deletes the old generation performance information D36 from the storage area 151B.

(A31) The acquisition unit 152 performs the sampling processing. The acquisition unit 152 compares the reference value RV (the performance information D36) and the latest performance information D39 with each other, and determines that a variation does not exceed the predetermined threshold value. Thus, the acquisition unit 152 does not store the performance information D39 in the storage area 151A (discarding). Accordingly, the reference value RV is still the performance information D36.

(A32) The acquisition unit 152 acquires the performance information D40. (A33) The acquisition unit 152 stores the performance information D40 in the storage area 151B. The acquisition unit 152 deletes the old generation performance information D37 from the storage area 151B.

(A34) The acquisition unit 152 performs the sampling processing. The acquisition unit 152 compares the reference value RV (the performance information D36) and the latest performance information D40 with each other, and determines that a variation rate does not exceed the predetermined threshold value. Thus, the acquisition unit 152 does not store the performance information D40 in the storage area 151A (discarding). Accordingly, the reference value RV is still the performance information D36.

As the acquisition unit 152 performs the processing of A1 to A34, data in the performance information 230A of FIG. 3A is selectively extracted to form the performance information 230B of FIG. 3B, so that a data amount is reduced. Also, for the performance information 210A as well, as the acquisition unit 152 performs the sampling processing, the data of the performance information D17 to D20 is not stored in the storage area 151A but discarded, so that a data amount is reduced. The system administrator may set the predetermined threshold value which is to be compared with a variation rate.

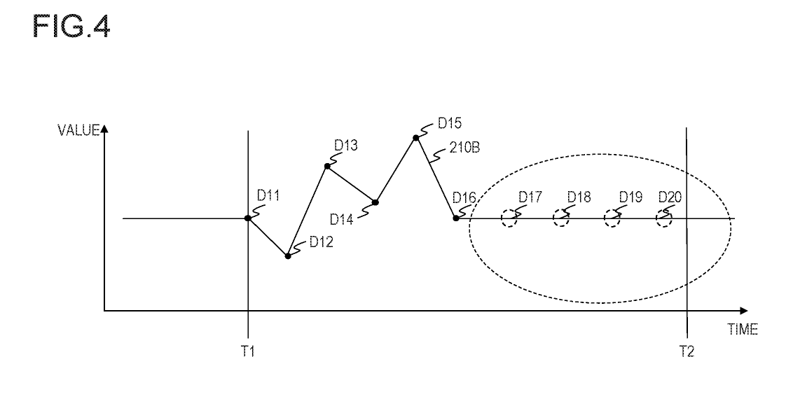

FIG. 4 illustrates an exemplary method for calculating a sampling rate. In FIG. 4, components similar to those in FIG. 3B are denoted by the similar reference numerals as used in FIG. 3B. The sampling rate refers to a rate of sampling (a rate of data extracted and stored in the storage area 151A) in a time period specified by the system administrator. Specifically, when the system administrator specifies T₁ and T₂, performance information to be subjected to the calculation of the sampling rate is the performance information D11 to D20. The sampling rate is calculated by Expression (1) below.

A sampling rate in the time period T₁ to T₂=100×(the number of performance information extracted in sampling processing÷the number of performance information in the time period T₁ to T₂ before the sampling processing) (1)

For example, in the case of the performance information 210B, the number of performance information extracted in the sampling processing is six (6) (the performance information D11 to D16). The number of performance information before the sampling processing is ten (10) (the performance information D11 to D20). Accordingly, the sampling rate becomes 60%.

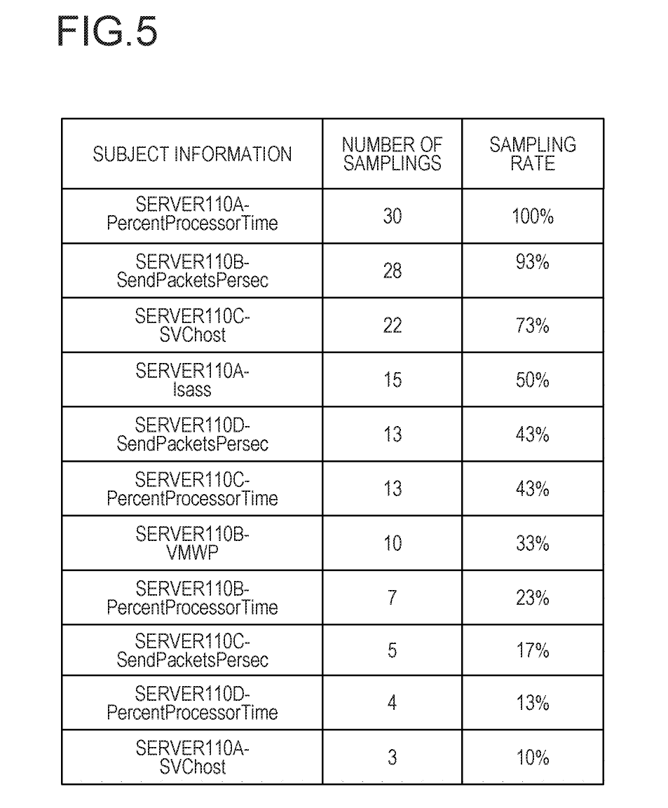

FIG. 5 illustrates an example of analysis candidate information indicating a sampling rate of performance information. The processing unit 153 extracts the performance information of each subject having a sampling rate larger than a predetermined threshold value. When extracting the performance information of each subject having a sampling rate larger than the predetermined threshold value, the processing unit 153 may generate analysis candidate information in which the performance information and the sampling rate or the like are associated with each other. The analysis candidate information is stored in the storage unit 151.

The analysis candidate information includes subject information, the number of samplings, and a sampling rate. The subject information includes, for example, information for identifying a server and performance measured within the server. Accordingly, the analysis candidate information includes performance of a plurality of servers, switches or the like. For example, a CPU usage rate of a server 110A is indicated as “Server 110A-PercentProcessorTime” in the analysis candidate information of FIG. 5. A network throughput of a server 110B is indicated as “Server 110B-SendPacketsPersec” analysis candidate information of FIG. 5.

The number of samplings is the number of data stored in the storage area 151A as a result of the sampling processing performed in a time period specified by the system administrator. The sampling rate is a value representing a rate of the number of samplings to the number of performance information before the sampling processing. In the analysis candidate information, the number of samplings and the value of the sampling rate are stored in association with the subject information.

In the analysis candidate information of FIG. 5, the subject information is arranged in a descending order of the corresponding sampling rates. The processing unit 153 extracts performance information having a sampling rate larger than a predetermined threshold value as analysis-candidate performance information. The system administrator may set the predetermined threshold value to be compared to a sampling rate.

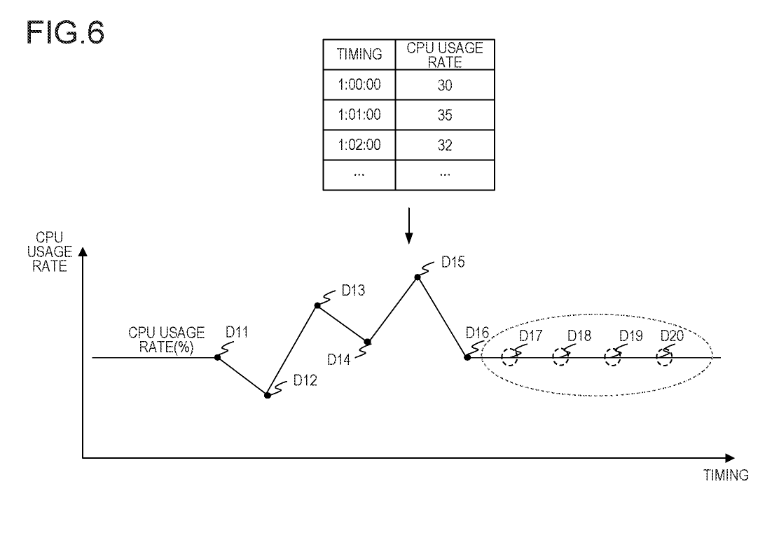

FIG. 6 illustrates an example of visualized performance information. The output unit 155 may visualize the analysis-candidate performance information in a form of, for example, a graph, a table, or the like to display the performance information on a monitor of the management terminal 160 or the like. Since the analysis-candidate performance information has a high sampling rate, a variation rate of the performance information is relatively large in a time period specified by the system administrator. Thus, when a time period of a system error has been specified, performance information having a high sampling rate is highly likely to become a cause of the system error. The output unit 155 may preferentially visualize performance information having a high sampling rate to output the performance information.

For example, the output unit 155 creates a graph by associating the data stored in the storage area 151A after the sampling processing with a measurement timing at which the data is measured. In that case, the output unit 155 may preferentially make a graph for the performance information having a high sampling rate and output the graph to a monitor used by the system administrator. The output unit 155 may allow the system administrator to designate the performance information to be visualized, from among the analysis-candidate performance information. The output unit 155 may display a plurality of performance information designated by the system administrator.

In the example of FIG. 6, six (6) performance information D11 to D16 is stored in the storage area 151A, and four (4) performance information D17 to D20 is discarded, in a time period specified by the system administrator. The measurement timing, at which each of the performance information D11 to D16 is measured, is stored in the storage area 151A. Thus, the output unit 155 may create a graph by associating the performance information D11 to D16 with the measurement timings thereof. For the discarded performance information D17 to D20, the output unit 155 may create a graph by setting the same value as the reference value D16, which has been compared to the performance information D17 to D20 in the sampling processing.

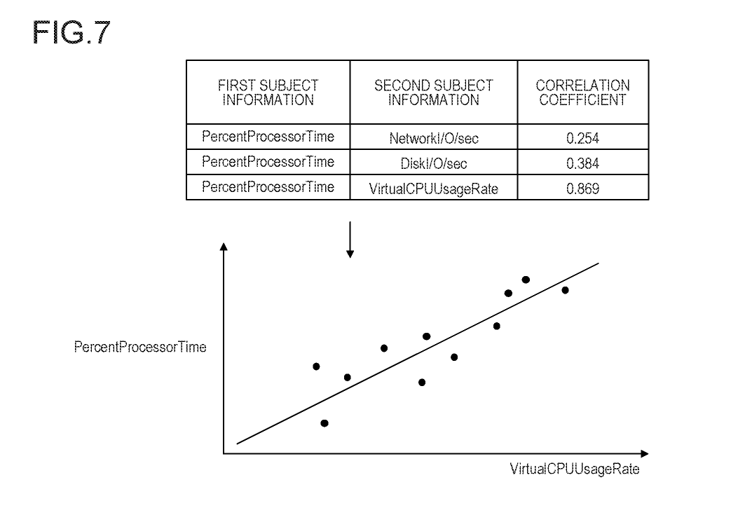

FIG. 7 illustrates an example of a correlation coefficient for a pair of analysis-candidate performance information. For all combinations of the extracted analysis-candidate performance information, the analysis unit 154 calculates a correlation coefficient for a pair of the analysis-candidate performance information. For example, FIG. 7 illustrates that a correlation coefficient between the PercentProcessorTime (CPU usage rate) as the first subject and the VirtualCPUUsageRate as the second subject is 0.869. As the correlation coefficient is closer to 1, a relationship between the subjects is closer.

The correlation of a pair of performance information of analysis candidate in the entire information processing system may be subjected to modeling (for example, a regression analysis) as illustrated in FIG. 7. The output unit 155 may visualize the information indicating a pair of performance information having a correlation coefficient larger than a predetermined threshold value in a form of, for example, the graph of FIG. 7 and displays the information on a monitor of the management terminal 160 or the like.

The system administrator may specify a time period where no error has occurred in the information processing system 100, and acquire information obtained from modeling of a pair of performance information having a high correlation coefficient among the performance information of respective subjects of the entire information processing device. Also, the system administrator may specify a time period where a system error has occurred, and acquire information obtained from modeling of a pair of performance information having a high correlation coefficient among the performance information of respective subjects in the entire information processing device. By comparing the models for the state that a system error is occurring and for the state that no system error is occurring, the subjects to be used in the analysis of performance information, such as analysis of a cause of a system error or detection of a symptom thereof, are decreased so that the system administrator may perform the analysis of performance information at a high speed.

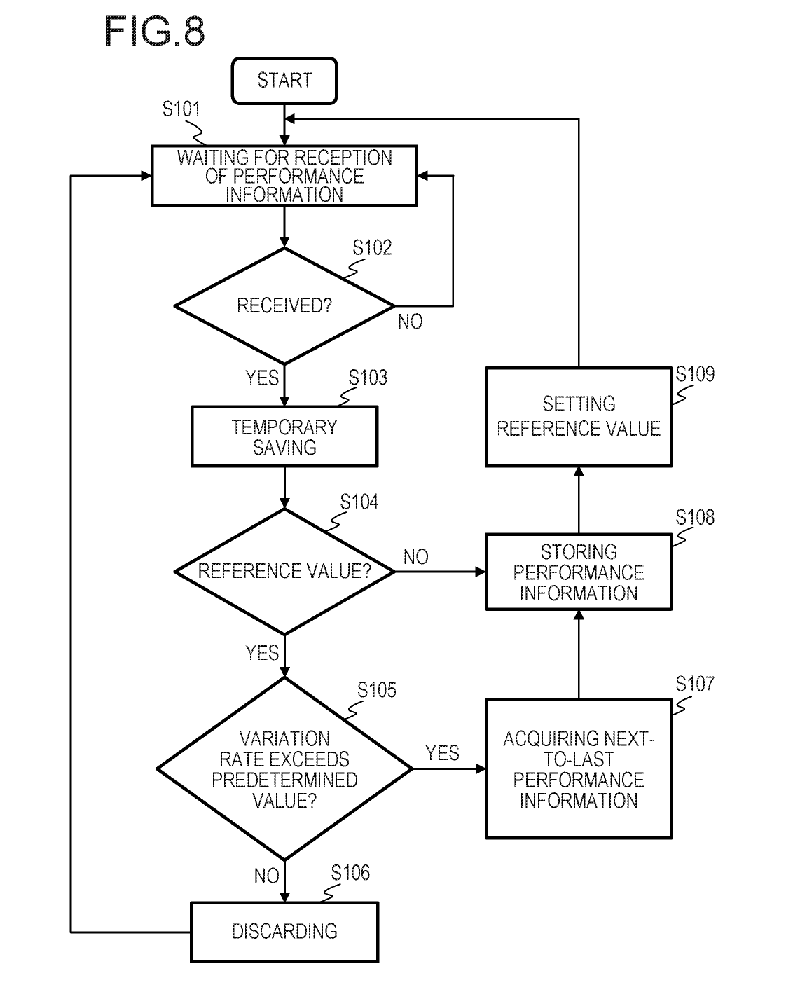

FIG. 8 illustrates an example of sampling processing. At S101, the acquisition unit 152 waits for performance information to be sent from the information processing device group 130. At S102, the acquisition unit 152 determines whether performance information has been sent from the information processing device group 130. If it is determined that performance information has not been sent from the information processing device group 130 (NO in S102), the acquisition unit 152 repeats the processing starting from S101. At S103, when the latest performance information is acquired from the information processing device group 130 (YES in S102), the acquisition unit 152 stores the latest performance information in the storage area 151B. At S104, the acquisition unit 152 determines whether a reference value has been set.

At S105, if a reference value has been set (YES in S104), the acquisition unit 152 determines whether a variation rate of the latest performance information and the reference value (for the same subject) exceeds a predetermined variation rate. At S106, if it is determined that the variation rate does not exceed the predetermined variation rate (NO in S105), the latest performance information is discarded. After S106, the acquisition unit 152 repeats the processing starting from S101.

At S107, if it is determined that the variation rate exceeds the predetermined variation rate (YES in S105), the acquisition unit 152 acquires, from the storage area 151B, the performance information, which has been acquired immediately before the latest performance information of the same subject as the latest performance information. At S108, the acquisition unit 152 stores the latest performance information and the next-to-last performance information, which has been received immediately before the latest performance information, in the storage area 151A. If the next-to-last performance information is already stored in the storage area 151A, the acquisition unit 152 stores only the latest performance information. If no reference value has been set (NO in S104), the acquisition unit 152 performs the processing of S108. At S109, the acquisition unit 152 sets the latest performance information stored in the storage area 151A as a reference value. After S109, the acquisition unit 152 repeats the processing starting from S101.

As described above, the acquisition unit 152 performs sampling processing, so that a data amount of performance information to be stored in the analysis device 150 may be reduced.

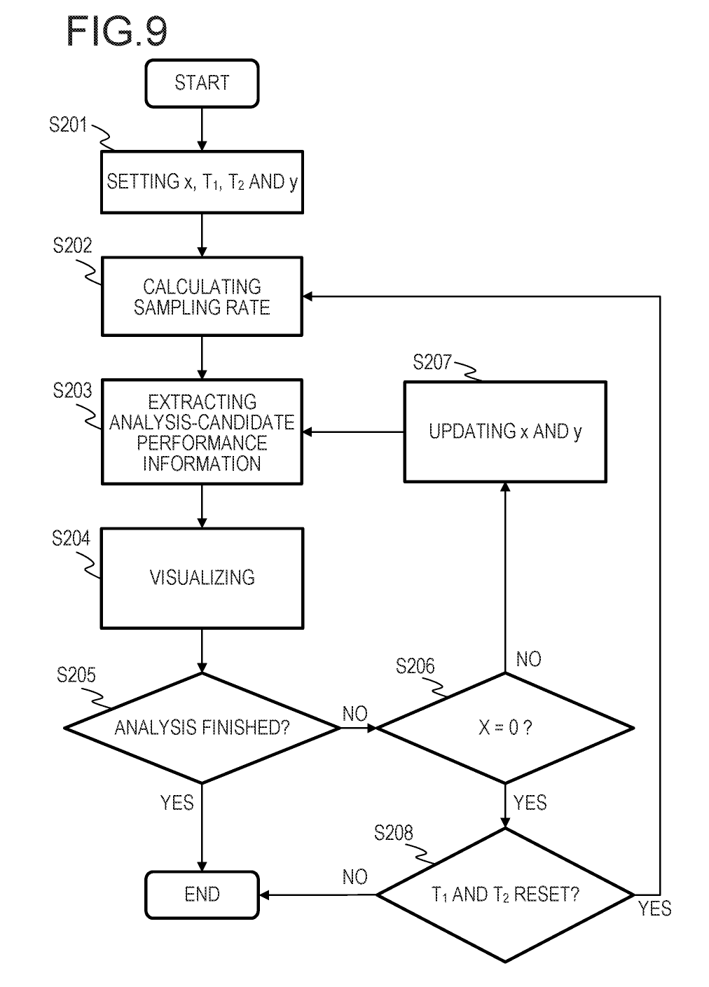

FIG. 9 illustrates an example of visualization analysis. At S201, the processing unit 153 acquires a specified threshold value x for a sampling rate and specified values for a time period T₁ to T₂. In addition, at S201, an upper limit threshold value y for a sampling rate is set to 100%. At S202, the processing unit 153 calculates a sampling rate for performance information of each subject in the specified time period T₁ to T₂. At S203, the processing unit 153 extracts the performance information of each subject having a sampling rate exceeding the threshold value x for the sampling rate and not exceeding the upper limit threshold value y, as analysis-candidate performance information. At S204, the output unit 155 visualizes and displays the extracted analysis-candidate performance information on a monitor of the management terminal or the like.

By using the visualized graph or the like, the system administrator identifies a pair of subject information having a relationship, for example, among the extracted performance information. At S205, the analysis unit 154 determines whether a request to finish the analysis processing has been acquired from the system administrator.

If it is determined that a request to finish the analysis processing has been acquired (if the system administrator has completed the analysis; YES in S205), the analysis device 150 finishes the analysis processing. At S206, if it is determined that there is no request to finish the analysis processing (NO in S205), the processing unit 153 determines whether the threshold value x for the sampling rate is zero (0). At S207, if it is determined that the threshold value x for the sampling rate is not zero (0) (NO in S206), the processing unit 153 sets the value set for the threshold value x as the upper limit threshold value y, and sets the threshold value x to be smaller than the current value. The system administrator may input and reset the threshold value x. The processing unit 153 may gradually reduce the threshold value x by a predetermined value. After S207, the processing unit 153 repeats the processing starting from S203.

At S208, if it is determined that the threshold value x for the sampling rate is zero (0) (YES in S206), the processing unit 153 determines whether the values for the time period T₁ to T₂ have been reset. If it is determined that the values for the time period T₁ to T₂ have not been reset (NO in S208), the analysis device 150 finishes the processing of the visualization analysis. If it is determined that the values for the time period T₁ to T₂ have been reset (YES in S208), the processing unit 153 repeats the processing starting from S202.

The processing of the visualization analysis in FIG. 9 is performed for the analysis-candidate performance information. The analysis-candidate performance information refers to the performance information having a high sampling rate and variation rate in a time period specified by the system administrator. The performance information having a high sampling rate in a time period where a system error is occurring is highly likely to be related to the system error. Accordingly, by notifying the system administrator of performance information having a high variation rate in a time period specified by the system administrator, the subjects to be used in the analysis of performance information, such as analysis of a cause of a system error or detection of a symptom thereof, are decreased so that the analysis of performance information may be performed at a high speed.

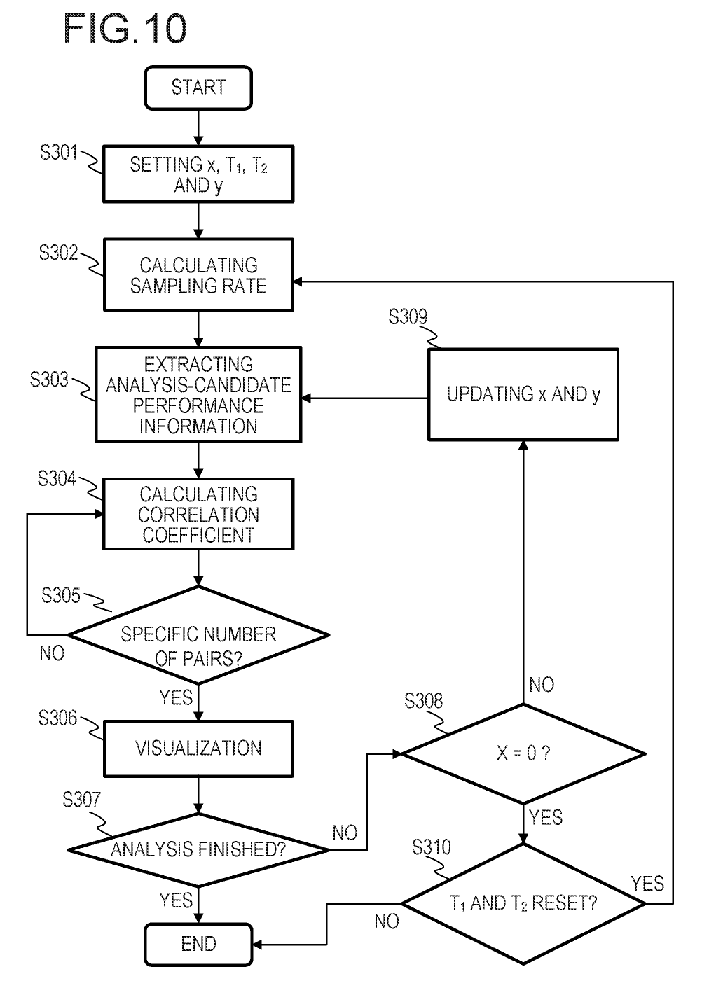

FIG. 10 illustrates an example of relationship analysis using a correlation coefficient. At S301, the processing unit 153 acquires a specified threshold value x for a sampling rate and specified values for a time period T₁ to T₂. In addition, at S301, an upper limit threshold value y for a sampling rate is set to 100%. At S302, the processing unit 153 calculates a sampling rate for performance information of each subject in the specified time period T₁ to T₂. At S303, the processing unit 153 extracts the performance information of each subject having a sampling rate exceeding the threshold value x for the sampling rate and not exceeding the upper limit threshold value y, as analysis-candidate performance information.

At S304, the analysis unit 154 preferentially calculates a correlation coefficient for a pair of performance information having a high sampling rate, among the analysis-candidate performance information. At S305, the analysis unit 154 determines whether a correlation coefficient has been calculated for a specific number for pairs of the performance information. If it is determined that a correlation coefficient has not been calculated for the specific number for pairs of the performance information (NO in S305), the analysis unit 154 repeats the processing starting from S304. At S306, the output unit 155 visualizes information, in which pair of subject information and a correlation coefficient are associated with each other, as a table and displays the table on a monitor of the management terminal or the like.

The system administrator may identify, for example, subjects having a correlation coefficient close to 1, by using the visualized graph, table, or the like. At S307, the analysis unit 154 determines whether a request to finish the analysis processing has been acquired from the system administrator.

If it is determined that a request to finish the analysis processing has been acquired (if the system administrator has completed the analysis; YES in S307), the analysis device 150 finishes the analysis processing. At S308, if it is determined that there is no request to finish the analysis processing (NO in S307), the processing unit 153 determines whether the threshold value x for the sampling rate is zero (0). At S309, if it is determined that the threshold value x for the sampling rate is not zero (0) (NO in S308), the processing unit 153 sets the value set for the threshold value x as the upper limit threshold value y, and sets the threshold value x to be smaller than the current value. The system administrator may input and reset the threshold value x. The processing unit 153 may gradually reduce the threshold value x by a predetermined value. After S309, the processing unit 153 repeats the processing starting from S303.

At S310, if it is determined that the threshold value x for the sampling rate is zero (0) (YES in S308), the processing unit 153 determines whether the values for the time period T₁ to T₂ have been reset. If it is determined that the values for the time period T₁ to T₂ have not been reset (NO in S310), the analysis device 150 finishes the processing of the relationship analysis. If it is determined that the values for the time period T₁ to T₂ have been set (YES in S310), the processing unit 153 repeats the processing starting from S302.

The system administrator may specify a time period where no error has occurred in the information processing system 100, and acquire a pair of performance information of each subject, which has a high correlation coefficient, in the entire information processing device, in order to determine subjects to be analyzed. Also, the system administrator may specify a time period where a system error has occurred, and acquire a pair of performance information of each subject, which has a high correlation coefficient, in the entire information processing device, in order to determine subjects affected by the system error. Thus, the subjects to be used in the analysis of performance information, such as analysis of a cause of a system error or detection of a symptom thereof, are decreased so that the system administrator may perform the analysis of performance information at a high speed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An analysis device, comprising:
a storage device configured to
store therein performance information of each of plural subjects, each of the plural subjects being any type of performance of any device or any process in an information processing device; and
a processor configured to
acquire first performance information of a first subject of the plural subjects from the information processing device,
compare the first performance information and a reference value with each other to calculate a variation rate, the reference value indicating performance information of the first subject previously stored in the storage device,
store the first performance information in the storage device when the variation rate exceeds a predetermined variation rate,
calculate a sampling rate for each of the plural subjects, the sampling rate indicating a ratio of a number of performance information stored in the storage device to a number of performance information acquired from the information processing device within a predetermined time period,
determine analysis candidate subjects which have a sampling rate higher than a predetermined sampling rate, and
analyze a relationship between performance information of the analysis candidate subjects on basis of the performance information stored in the storage device.

2. The analysis device according to claim 1, wherein
the processor is configured to
preferentially calculate a correlation coefficient of performance information for a combination of subjects having higher sampling rates among the analysis candidate subjects, and
identify a combination of subjects having a higher correlation coefficient of performance information among combinations of the analysis candidate subjects.

3. An information processing system: comprising:
an information processing device; and
an analysis device including:
a storage device configured to
store therein performance information of each of plural subjects, each of the plural subjects being any type of performance of any device or any process in the information processing device, and
a processor configured to
acquire first performance information of a first subject of the plural subjects from the information processing device,
compare the first performance information and a reference value with each other to calculate a variation rate, the reference value indicating performance information of the first subject previously stored in the storage device,
store the first performance information in the storage device when the variation rate exceeds a predetermined variation rate,
calculate a sampling rate for each of the plural subjects, the sampling rate indicating a ratio of a number of performance information stored in the storage device to a number of performance information acquired from the information processing device within a predetermined time period,
determine analysis candidate subjects which have a sampling rate higher than a predetermined sampling rate, and
analyze a relationship between performance information of the analysis candidate subjects on basis of the performance information stored in the storage device.

4. The information processing system according to claim 3, wherein
the processor is configured to
preferentially calculate a correlation coefficient of performance information for a combination of subjects having higher sampling rates among the analysis candidate subjects, and
identify a combination of subjects having a higher correlation coefficient of performance information among combinations of the analysis candidate subjects.

5. A computer-readable recording medium having stored therein a program that causes a computer to execute a process, the process comprising:
acquiring first performance information of a first subject from an information processing device;
comparing the first performance information and a reference value with each other to calculate a variation rate, the reference value indicating performance information of the first subject previously stored in a storage device configured to store therein performance information of each of plural subjects, each of the plural subjects being any type of performance of any device or any process in the information processing device, the first subject being one of the plural subjects;
storing the first performance information in the storage device when the variation rate exceeds a predetermined variation rate;
calculating a sampling rate for each of the plural subjects, the sampling rate indicating a ratio of a number of performance information stored in the storage device to a number of performance information acquired from the information processing device within a predetermined time period;
determining analysis candidate subjects which have a sampling rate higher than a predetermined sampling rate; and
analyzing a relationship between performance information of the analysis candidate subjects on basis of the performance information stored in the storage device.

6. The computer-readable recording medium according to claim 5, the process comprising:
preferentially calculating a correlation coefficient of performance information for a combination of subjects having higher sampling rates among the analysis candidate subjects; and
identifying a combination of subjects having a higher correlation coefficient of performance information among combinations of the analysis candidate subjects.
